(19) United States
(12) Patent Application Publication
(10) Pub. No.: US 2025/0306441 A1
(43) Pub. Date: Oct. 2, 2025

(54) DISASSEMBLY AND ASSEMBLY STRUCTURE, PHOTOGRAPHY ACCESSORY KIT, AND ELECTRONIC DEVICE KIT

(71) Applicant: TILTA INC., Burbank, CA (US)

(72) Inventors: Zhichao FENG, Shenzhen (CN); Wenping ZENG, Shenzhen (CN); Kefeng ZHOU, Shenzhen (CN)

(21) Appl. No.: 19/082,604

(22) Filed: Mar. 18, 2025

(30) Foreign Application Priority Data
Apr. 1, 2024 (CN) 2024206599824

(51) Int. Cl. G03B 17/56; H04M 1/02

(52) U.S. Cl. CPC G03B 17/566; H04M 1/0203

(57) ABSTRACT

The present disclosure introduces a disassembly and assembly structure, a photography accessory kit, and an electronic device kit, featuring: a mounting base and a quick-release assembly. The quick-release assembly includes a clamping member and a trigger. The clamping member is movably installed on the mounting base and includes a first clamping member and a second clamping member positioned opposite each other. The trigger, also movably installed on the mounting base, is equipped with a first groove and a second groove, corresponding to the first clamping member and the second clamping member, respectively. The first clamping member fits within the first groove, and the second clamping member fits within the second groove. The triggering member can activate the first clamping member and the second clamping member to move apart from or towards each other via the first groove and the second groove.

### CROSS-REFERENCE TO RELATED APPLICATIONS

The present application for patent claims priority to and the benefit of pending Chinese Application No. 2024206599824, filed Apr. 1, 2024, and hereby expressly incorporated by reference herein as if fully set forth below in its entirety and for all applicable purposes.

### TECHNICAL FIELD

This present disclosure pertains to the realm of photography accessories, specially addressing a disassembly and assembly structure, a photography accessory kit, and an electronic device kit.

### INTRODUCTION

As photography and videography become increasingly prevalent in everyday life, more individuals are engaging in shooting activities as part of their routines. During the shooting and imaging process, diverse composition needs often arise, necessitating the attachment of various photographic accessories, such as lights and camera grips, to electronic devices used for shooting. Taking the camera grip as an example, users typically attach photographic accessories to the casing of electronic devices by screwing them in place. When replacing photographic accessories, users can utilize specialized tools like hex key wrenches for disassembly. The procedure involves removing the equipment in use, then installing replacement accessories. While this method provides relatively stable mounting of photographic accessories onto the casing of electronic devices, the process is cumbersome and significantly impacts the shooting experience.

### BRIEF SUMMARY

The present disclosure introduces a disassembly and assembly structure that mitigates the challenges associated with installing and removing various photography accessories, thereby enhancing the user's shooting experience.

The present disclosure introduces the following solution:
a disassembly and assembly structure including:
a mounting base;
a quick-release assembly including a clamping member and a trigger; wherein the clamping member is movably installed on the mounting base and includes a first clamping member and a second clamping member positioned opposite each other, the trigger is movably installed on the mounting base and is equipped with a first groove and a second groove corresponding to the first clamping member and the second clamping member, respectively, the first clamping member fits within the first groove, the second clamping member fits within the second groove, and the trigger can activate the first clamping member and the second clamping member to move apart from or towards each other via the first groove and the second groove.

### BRIEF DESCRIPTION OF THE DRAWINGS

To elucidate the technical solutions presented in some aspects of the present disclosure, the accompanying drawings for describing these examples will be briefly introduced below. It is apparent that the accompanying drawings described herein represent merely some examples of the present disclosure. For those skilled in the art, without the necessity for inventive effort, other drawings can be derived based on the structures depicted in these drawings.

FIG. 1 is a diagram illustrating an exploded diagram of a disassembly and assembly structure according to some aspects of the disclosure.

FIG. 2 is a diagram illustrating a front view of the disassembly and assembly structure according to some aspects of the disclosure.

FIG. 3 is a diagram illustrating a cross-sectional diagram at a section line A-A in FIG. 2.

FIG. 4 is a diagram illustrating a top view of the disassembly and assembly structure according to some aspects of the disclosure.

FIG. 5 is a diagram illustrating a cross-sectional diagram at a section line B-B in FIG. 4.

FIG. 6 is a diagram illustrating a locking component according to some aspects of the disclosure.

FIG. 7 is a diagram illustrating an another perspective of the locking component of FIG. 6 according to some aspects of the disclosure.

FIG. 8 is a diagram illustrating a photography accessory kit according to some aspects of the disclosure.

FIG. 9 is a diagram illustrating an electronic device kit according to some aspects of the disclosure.

FIG. 10 is a diagram illustrating a front view of another example of the disassembly and assembly structure according to some aspects of the disclosure.

FIG. 11 is a diagram illustrating a cross-sectional diagram of the disassembly and assembly structure of FIG. 10 according to some aspects of the disclosure.

### REFERENCE NUMBERS

100—electronic device kit; 101—disassembly and assembly structure; 102—housing; 1021—accommodation cavity; 1022—first housing; 1023—second housing; 1024—first through hole; 1025—second through hole; 1026—first mounting interface; 1027—second mounting interface; 1028—first electronic contact; 103—control module; 104—mobile phone; 200—photography accessory kit; 201—photography accessory; 2011—docking station; 2012—electronic interface; 2013—power supply cable; 2014—sliding strip;
1—mounting base; 11—mounting groove;
2—quick—release assembly; 21—clamping member; 211—first clamping member; 2111—first clamping part; 212—second clamping member; 2121—second clamping part; 213—first inclined surface; 214—second inclined surface; 215—locking projection; 22—trigger; 221—first groove; 222—second groove; 223—inner wall; 224—limiting groove; 225—trigger button; 226—trigger block; 227—accommodation groove;
3—locating part; 31—first limiting post; 32—second limiting post; 33—first resetting elastic element; 34—second resetting elastic element;
4—locking component; 41—wrench part; 42—locking part; 421—locking groove; 422—avoidance position; 43—locking post;
5—expansion interface.

The objectives, functional characteristics, and advantages of the present disclosure will be further elucidated with reference to some aspects and accompanying drawings.

### DETAILED DESCRIPTION

Aspects of the present disclosure provide a portrayal of the technical solutions embodied within the disclosure, drawing upon the illustrative figures. It is to be understood that the enumerated examples constitute but a fraction of the broader scope and are not exhaustive. Consequently, any alternative examples derived by ordinary technicians in the relevant field, without the necessity for inventive ingenuity, are encompassed within the protective ambit of the disclosure.

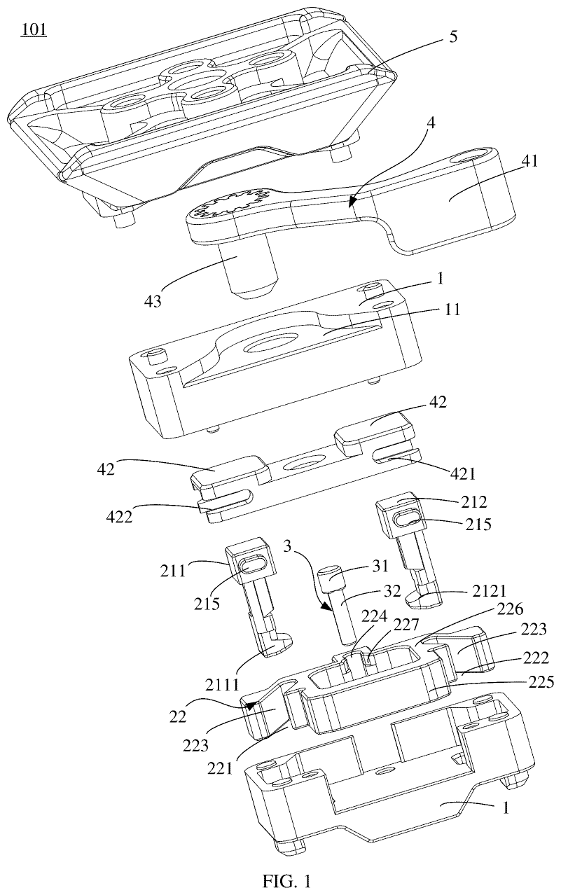

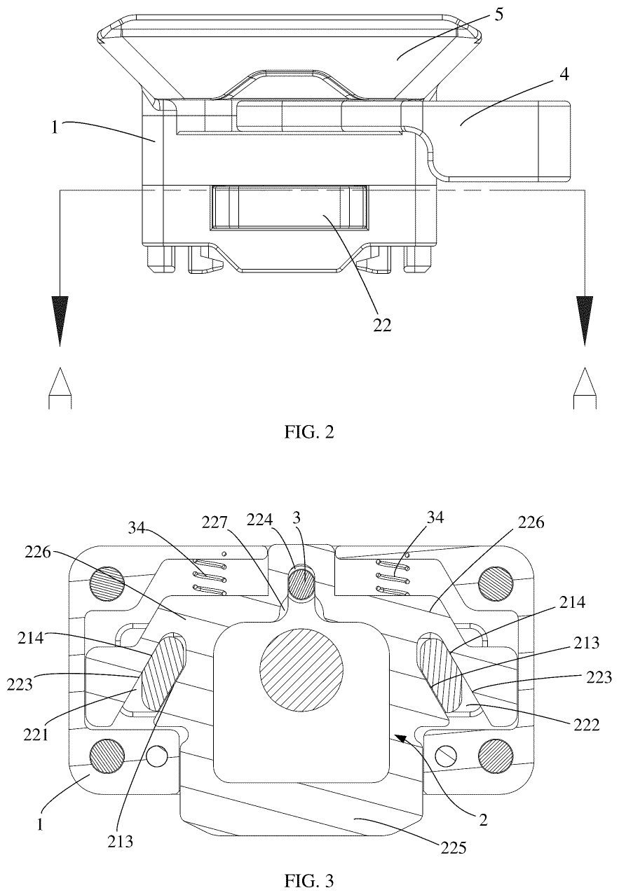

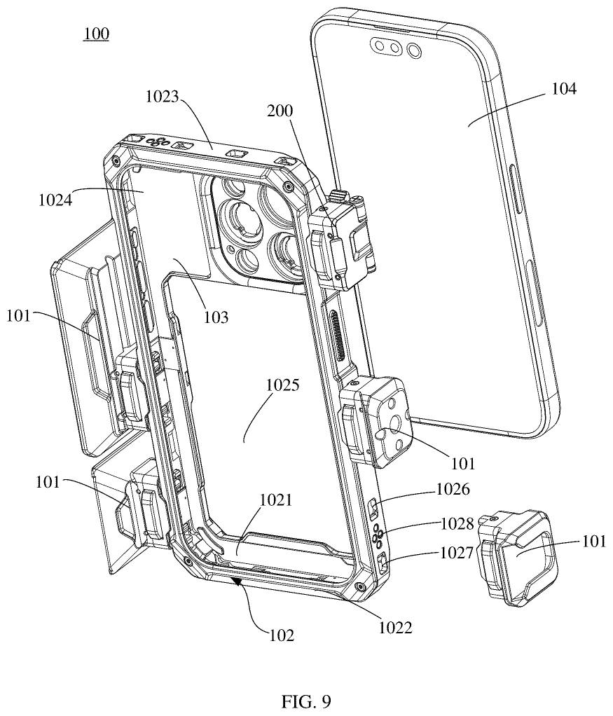

Referring to FIGS. 1-11, the present disclosure discloses an electronic device kit 100 utilizing a disassembly and assembly structure 101. The kit includes the disassembly and assembly structure 101 and a housing 102 (see exemplary assembly structure 101 and a housing 102 in FIG. 9). The housing 102 features an accommodation cavity 1021 designed to hold an electronic device, such as a mobile phone 104 (e.g., a smartphone). The disassembly and assembly structure 101 is installed on the housing 102, serving as a base for attaching photography accessories 201 (e.g., accessory 201 in FIG. 8).

The housing 102 fulfills the primary function of accommodating and securing the mobile phone 104 in the housing. One or more disassembly and assembly structure 101 can be located on the housing 102, to provide a platform for mounting diverse photography accessories 201. Each accessory 201 can integrate with the disassembly and assembly structure 101 to form a unified structure or attach through industry-standard interfaces (such as Nato, threaded, cold shoe, quick-release plate, etc.). In some aspects, multiple disassembly and assembly structures 101 can be deployed, with each capable of accommodating at least one accessory, thereby enabling multiple photography accessory kits 200. When a photographer desires to switch or change to another accessory kit 200, the current accessory 201 can be swiftly detached from the housing 102 of the electronic device via the disassembly and assembly structure 101, and the disassembly and assembly structure 101 of the replacement accessory 201 can be promptly installed onto the housing 102, enhancing photographic convenience.

In an example illustrated in FIG. 9, the housing 102 includes a first housing 1022 and a second housing 1023. The first housing 1022 features a first through hole 1024 for exposing a display of the mobile phone 104. The first housing 1022 and the second housing 1023 enclose to form the accommodation cavity 1021. The second housing 1023 features a second through hole 1025 aligned with the first through hole 1024 to expose the back side of the mobile phone 104 opposite the display screen.

Furthermore, to facilitate mobile phone 104 fixation in the housing 102, the first housing 1022 and the second housing 1023 are detachably connected, possibly through clipping or screwing mechanisms.

In some aspects, the first housing 1022 and the second housing 1023 are connected using threaded connectors (such as screws or bolts). In operation, the threaded connectors are removed to separate the first housing 1022 and the second housing 1023, enabling the mobile phone 104 to be placed with its non-display side contacting the mounting surface without impeding functionality. Subsequently, the second housing 1023 is reconnected to the first housing 1022 to get integrated using the threaded connectors, securing and positioning the mobile phone 104.

Referring to FIGS. 1-3, the disassembly and assembly structure 101 includes a mounting base 1 and a quick-release assembly 2. The quick-release assembly 2 includes a clamping member 21 and a trigger 22. The clamping member 21 is movably mounted on the mounting base 1 and includes a first clamping member 211 and a second clamping member 212 positioned opposite each other (e.g., on opposite sides of the mounting base 1). The trigger 22 is also movably mounted on the mounting base 1 and features a first groove 221 and a second groove 222 corresponding to the first clamping member 211 and the second clamping member 212, respectively. The first clamping member 211 fits within the first groove 221, and the second clamping member 212 fits within the second groove 222. The trigger 22 can manipulate the first clamping member 211 and the second clamping member 212 to move apart or closer together through the respective grooves.

In some aspects, activating the trigger 22 causes the first clamping member 211 and the second clamping member 212 to move apart via the first groove 221 and the second groove 222, increasing the clamping space between the first clamping member 211 and the second clamping member 212 and placing the mechanism (disassembly and assembly structure 101) in a standby installation state. When the first clamping member 211 and the second clamping member 212 are installed on the housing 102, the trigger 22 resets (released from an activated state), driving the first clamping member 211 and the second clamping member 212 closer together via the first groove 221 and the second groove 222, securing the disassembly and assembly structure 101 to the housing 102 in a clamped state. In this example, the quick-release assembly 2 enables the quick installation and removal of the disassembly and assembly structure 101 from the housing 102. When a photography accessory 201 is attached to the disassembly and assembly structure 101, the photography accessory can be swiftly attached to or detached from the housing 102 via the disassembly and assembly structure 101, simplifying the photography process for users.

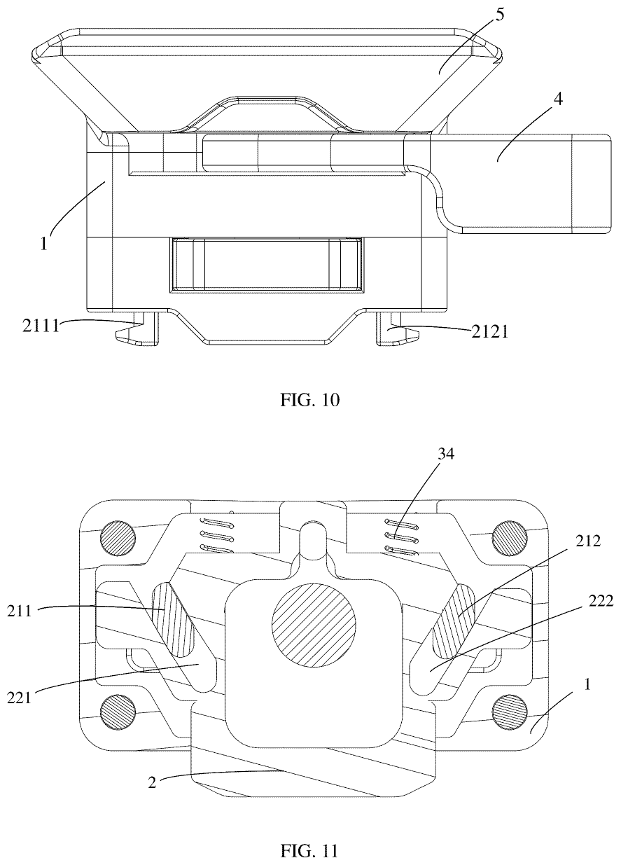

In some aspects, referring to FIGS. 10-11 depending on requirements, the first clamping part 2111 and the second clamping part 2121 can be configured to extend in mutually opposite directions. The first groove 221 of the trigger 22 and the second groove 222 of the trigger 22 drive the first clamping member 211 and the second clamping member 212 to move close to each other, positioning in a ready-to-install configuration. Upon installation of the first clamping member 211 and the second clamping member 212 onto the housing 102, the trigger 22 resets, further driving the first clamping member 211 and the second clamping member 212 apart via the first groove 221 and the second groove 222, thereby placing the first clamping member 211 and the second clamping member 212 in a clamping configuration (secured configuration).

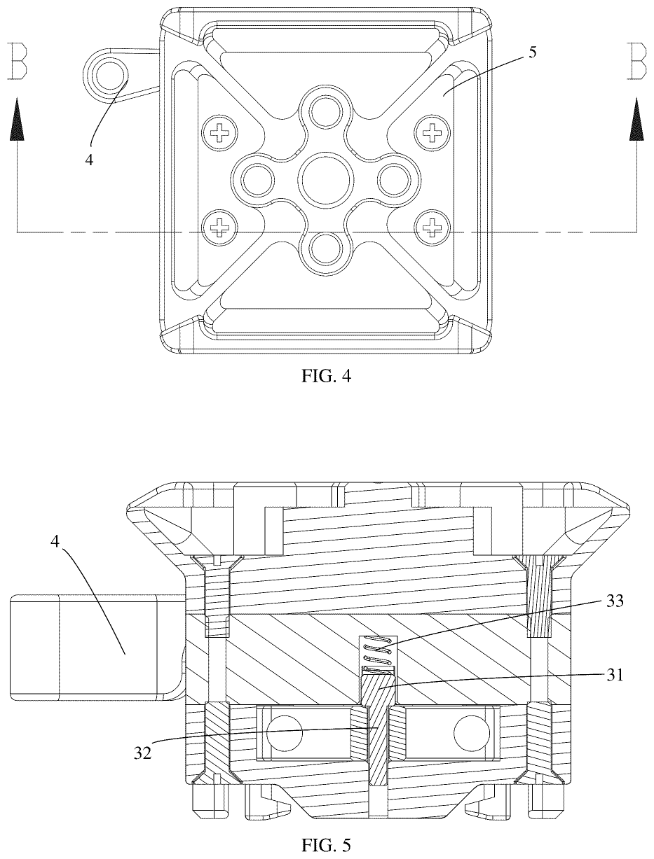

In some aspects, referring to FIGS. 3-4, the inner walls 223 of both the first groove 221 and the second groove 222 are beveled. This beveling allows the first clamping member 211 to engage with the beveled inner wall 223 of the first groove 221 and the second clamping member 212 to engage with the beveled inner wall 223 of the second groove 222. This arrangement facilitates the movement of the first clamping member 211 towards or away from the second clamping member 212, when the clamping members move in their respective grooves. In one aspect, when the trigger 22 is pressed, the beveled inner walls 223 of the first groove 221 and the second groove 222 guide the first clamping member 211 and the second clamping member 212 along the inner walls 223, enabling the installation of the disassembly and assembly structure 101 onto the housing 102 of an electronic device. Upon installation, the trigger 22 resets (e.g., return to an unpressed position). Subsequently, the beveled inner walls 223 of the first groove 221 and the second groove 222 cause the first clamping member 211 and the second clamping member 212 to reset as well, clamping the first clamping member 211 and the second clamping member 212 onto the housing 102 of the electronic device. Notably, both clamping members, 211 and 212, possess first inclined surfaces 213 and second inclined surfaces 214 on opposing sides of the clamping members, with at least one of these inclined surfaces abutting against the inner walls 223 of the first groove 221 and the second groove 222, respectively. In some aspects, the first inclined surface 213 and the second inclined surface 214 are set parallel to each other. Additionally, a curved surface can be utilized to transition between the first inclined surface 213 and the second inclined surface 214, promoting smooth movement within the first groove 221 and the second groove 222, respectively.

In other aspects, referring to FIGS. 1 and 4-5, the disassembly and assembly structure 101 further includes a locating part 3 (e.g., a locating pole). The trigger 22 is equipped with a limiting groove 224, and the locating part 3 is accommodated within the limiting groove 224 while being movably connected to the mounting base 1. When the trigger 22 moves towards the locating part 3, the locating part 3 can disengage from the limiting groove 224 and restrict the movement of the trigger 22. The locating part 3 can also move outside the mounting base 1, allowing part of its structure to protrude beyond the mounting base 1. Specifically, in some aspects, the trigger 22 includes a trigger button 225 and a trigger block 226. The trigger button 225 is connected to the trigger block 226 and exposed, at least partially, outside the mounting base 1. The trigger block 226 is movably connected to the mounting base 1. The first groove 221 and the second groove 222 are inclined in opposite directions from an end of the trigger block 226 near the locating part 3. When the trigger button 225 is pressed, moving the trigger block 226 towards the locating part 3 causes the first clamping member 211 and the second clamping member 212 to move apart, placing the mechanism in a ready-to-install configuration. When the first clamping member 211 and the second clamping member 212 clamp onto an external structure, this external structure can activate the locating part 3 to reset inside the mounting base 1, causing the trigger block 226 to reset as well and placing the first clamping member 211 and the second clamping member 212 in a clamped configuration. In some aspects, the external structure can be the housing 102 of an electronic device. In the installed state, the first clamping member 211 and the second clamping member 212 are spaced apart, with the locating part 3 also exposed outside the mounting base 1. When the first clamping member 211 and the second clamping member 212 clamp onto the housing 102 of the electronic device, the locating part 3 presses against the outer sidewall of the housing 102, moving towards the interior of the mounting base 1. At this point, the trigger block 226 can reset, and the locating part 3 re-engages within the limiting groove 224, placing the first clamping member 211 and the second clamping member 212 in a clamped configuration.

In some aspects, the locating part 3 (e.g., a locating pole) includes a first limiting post 31 and a second limiting post 32. A first resetting elastic element 33 is positioned between the first limiting post 31 and the base 1. The diameter of the first limiting post 31 is larger than that of the second limiting post 32. The second limiting post 32 can engage within the limiting groove 224. When the trigger button 225 is pressed, the trigger block 226 is pushed to move, causing the second limiting post 32 to disengage from the limiting groove 224. At this point, the first resetting elastic element 33 prompts the second limiting post 32 to move (e.g., at least partially protrude) outside the mounting base 1, with the first limiting post 31 following the movement of the second limiting post 32. Due to the larger diameter of the first limiting post 31 compared to the second limiting post 32, it is challenging for the first limiting post 31 to engage within the limiting groove 224, thereby restricting the movement of the trigger block 226. At this point, the first clamping member 211 and the second clamping member 212 are in a ready-to-install configuration (e.g., moved apart). When the first clamping member 211 and the second clamping member 212 clamp onto the housing 102 of the electronic device, the second limiting post 32 presses against the outer sidewall of the housing 102, moving towards the interior of the mounting base 1. At this stage, the first limiting post 31 moves inward towards the mounting base 1, with the first resetting elastic element 33 in a compressed condition. The first limiting post 31 ceases to restrict the movement of the trigger block 226, enabling immediate resetting of the trigger block 226. Subsequently, the second limiting post 32 re-engages within the limiting groove 224, securing the first clamping member 211 and the second clamping member 212 in a clamped configuration. In further detail, the trigger block incorporates an accommodation groove 227 designed to house the first limiting post 31 and is in communication with the limiting groove 224. Upon pressing the trigger button 225, the trigger block 226 is propelled to move, facilitating the exit of the second limiting post 32 from the limiting groove 224. At this juncture, the first limiting post 31 can be seated within the accommodation groove 227 to restrict the movement of the trigger block 226. When the second limiting post 32 presses against the outer sidewall of the housing 102, causing the movement of the second limiting post 32 inward towards the mounting base 1, the first limiting post 31 exits the accommodation groove 227, resetting the trigger block, and re-engaging the second limiting post 32 within the limiting groove 224. Notably, in some aspects, one or more second resetting elastic elements 34 can be positioned between the trigger block 226 and the mounting base 1. Once the first limiting post 31 exits the accommodation groove 227, the second resetting elastic element 34 can facilitate the resetting of the trigger block 226.

In some aspects, referring to FIGS. 1 and 6-7, the disassembly and assembly structure 101 includes a locking component 4, movably installed on the mounting base 1 and collaborating with the first clamping member 211 and the second clamping member 212 to secure the first clamping member 211 and/or the second clamping member 212. In some aspects, the locking component 4 offers secondary locking for the disassembly and assembly structure 101 onto the housing 102, significantly minimizing the gap between the disassembly and assembly structure 101 and the housing 102, thereby enabling ultra-stable installation of the photography accessory 201 onto the housing 102. Specifically, when the first clamping member 211 and the second clamping member 212 are clamped onto the housing 102, the locking component 4 can be manipulated to ensure that the first clamping member 211 and the second clamping member 212 are not only clamped but also locked. When disassembly is necessary, the locking component 4 is loosened by user, reverting the first clamping member 211 and the second clamping member 212 return to a clamped state. The operation further triggers the trigger 22, causing the first clamping member 211 and the second clamping member 212 to separate and revert to a ready-to-install position, allowing detachment of the disassembly and assembly structure 101 from the housing 102.

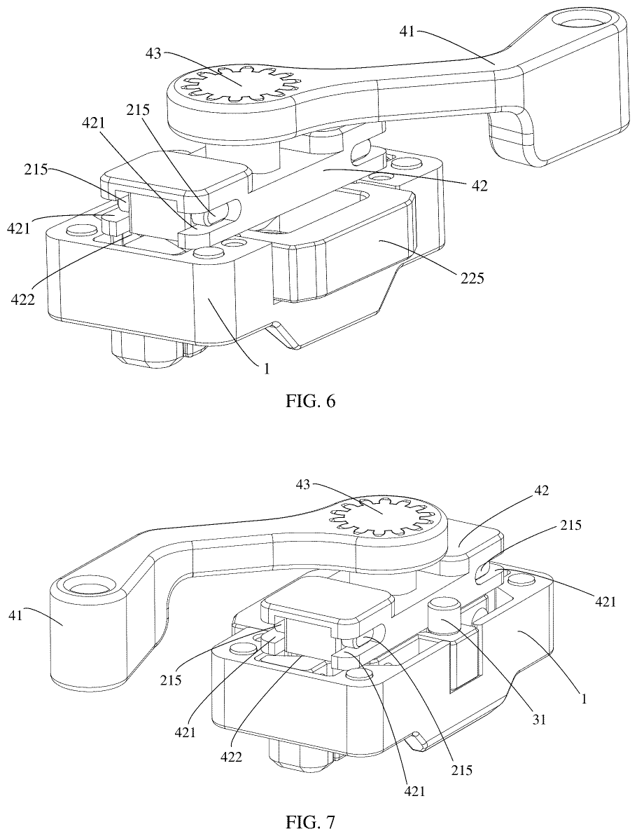

Referring to FIG. 6, the locking component 4 includes a wrench part 41 (e.g., a lever), a locking part 42 (e.g., a locking block), and a locking post 43. The locking part 42 is movably mounted on the mounting base 1 and works in tandem with both the first clamping member 211 and the second clamping member 212. One end of the locking post 43 is connected (e.g., threaded) to the locking part 42, while the other end of the locking post 43 connects to the wrench part. Actuating the wrench part 41 enables the wrench part 41 to propel the locking part 42 via the locking post 43, allowing the locking part 42 to secure the first clamping member 211 and the second clamping member 212 onto an external device. Specifically, in some aspects, due to the threaded connection between the locking post 43 and the locking part 42, rotating the wrench part causes the locking part 42 to move closer to the upper end of the mounting base 1 relative to the threads of the locking post 43, tightening the space between the wrench part 41, the upper end of the mounting base 1, and the locking part 42. As the locking part 42 moves towards the upper end of the mounting base 1, it pulls the first clamping member 211 and the second clamping member 212 closer to the upper end, tensioning the housing 102 via the first clamping member 211 and the second clamping member 212, thereby locking the quick-mounting mechanism onto the housing 102. It is noteworthy that the upper end of the mounting base 1 referenced in some aspects generally pertains to the end closer to the attached accessory. The wrench part in some aspects can be a locking wrench, engageable with the end of the locking post 43 opposite the locking part 42 via engaging teeth (e.g., a gear).

Referring to FIGS. 1 and 6, the interaction between the locking part 42 and the first clamping member 211 and the second clamping member 212 is as follows: both ends of the locking part 42 feature locking grooves 421, while the first clamping member 211 and the second clamping member 212 include locking projections 215 that fit within the locking grooves 421, enabling the locking part 42 to secure the first clamping member 211 and the second clamping member 212 onto an external device. In some aspects, when the first clamping member 211 and the second clamping member 212 are clamped, tightening causes the wrench part 41 to rotate relative to the locking post 43, prompting the locking part 42 to move towards the upper end of the mounting base 1. Furthermore, as the locking projections 215 of both the first clamping member 211 and the second clamping member 212 are engaged in the locking grooves 421 of the locking part 42, movement of the locking part 42 pulls the first clamping member 211 and the second clamping member 212 together, placing the first clamping member 211 and the second clamping member 212 in a locked state beyond the clamped configuration. When disassembly is required, loosening the wrench part 41 releases the locking part 42, allowing the first clamping member 211 and the second clamping member 212 to revert from the dual-locked state to the clamped state, further triggering the trigger 22 to separate the first clamping member 211 and the second clamping member 212, reverting to the ready-to-install position, thereby enabling detachment of the disassembly and assembly structure 101 from the housing 102.

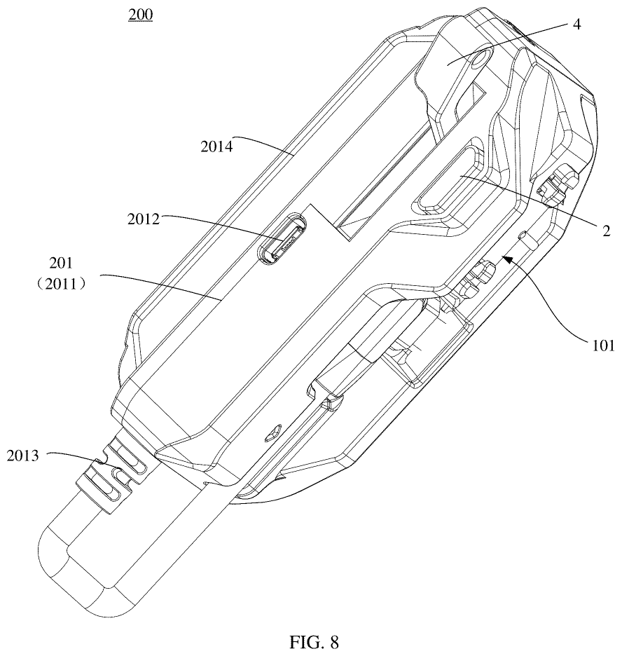

Specifically, referring to FIGS. 6 and 7, at least one locking projection 215 can be positioned on both the first clamping member 211 and the second clamping member 212, with corresponding locking grooves 421 for the locking projections 215 located on the locking part 42. Using FIGS. 6 and 7 as an illustration, one locking projection 215 is placed on opposing sides of both the first clamping member 211 and the second clamping member 212. At each end of the locking part 42, two locking grooves 421 corresponding to the locking projections 215 are situated, with an avoidance position 422 between the two locking grooves 421 to accommodate the top end of either the first clamping member 211 or the second clamping member 212. Considering the first clamping member 211 as an example, the first clamping member 211 can engage within one of the avoidance positions 422, with the locking projections 215 on opposite sides engaging in the respective two locking grooves 421. This arrangement ensures that when the locking part 42 moves toward the top of the mounting base 1, either the first clamping member 211 or the second clamping member 212 can be pulled evenly, facilitating a smooth locking process.

The part of the first clamping member 211 extending beyond the mounting base 1 is equipped with a first clamping part 2111, while the part of the second clamping member 212 extending beyond the mounting base 1 is equipped with a second clamping part 2121. The disassembly and assembly structure 101 further incorporates an expansion interface 5, positioned at one end of the mounting base 1 distant from the first clamping part 2111 and the second clamping part 2121 (e.g., see FIG. 1). A mounting groove 11 is provided on one side of the mounting base 1 adjacent to the expansion interface 5, within which the wrench part 41 is movably installed. It is noted that the aforementioned upper end of the mounting base 1 refers to the end distant from the first clamping part 2111 and the second clamping part 2121. In some aspects, the disassembly and assembly structure 101 can connect a photography accessory 201 via the expansion interface 5 on the mounting base 1. Each type of photography accessory 201 can be mounted onto one disassembly and assembly structure 101 to form a photography accessory kit 200, allowing users to switch different photography accessory kits 200 on the electronic device housing 102 according to their requirements. In some aspects, clamping primarily occurs through the first clamping part 2111 and the second clamping part 2121 onto the electronic device's housing 102. When clamped, the first clamping part 2111 and the second clamping part 2121 can be pulled by the collaboration of the wrench part 41, the locking post 43, and the locking part 42, directing the first clamping part 2111 and the second clamping part 2121 toward the photography accessory 201, thereby achieving a secondary lock onto the electronic device's housing 102. It is evident that the expansion interface 5 in some aspects includes, but is not limited to, interfaces within the photography industry such as a ¼-inch threaded interface, a ⅜-inch threaded interface, a cold shoe interface, a quick-release plate interface, an Arri locating interface, a dovetail groove, among others, for expanding and connecting diverse photography accessories 201. Notably, in another aspect, various photography accessories 201 can also be integrally provided with the mounting base 1.

In summary, photography users can install the disassembly and assembly structure 101 described in this disclosure onto external devices, such as onto a mobile phone kit's housing 102, with great convenience and speed. In this regard, this disclosure also presents a photography accessory kit 200, including an accessory and the aforementioned disassembly and assembly structure 101. The accessory includes, but is not limited to, filter mounts, docking stations 2011, lights, power banks, microphones, handles, and so forth. These accessories can be connected to the disassembly and assembly structure 101. Subsequently, the first clamping member 211 and the second clamping member 212 clamp onto the mobile phone kit's housing 102. Using the docking station 2011 as an example in some aspects, referring to FIG. 8. The docking station 2011 includes at least one electronic interface 2012 and at least one power supply cable 2013 for communicating with or powering external devices (like a mobile phone 104). A sliding strip 2014 is also provided on the side of the docking station 2011 facing away from the disassembly and assembly structure 101 for expanding connections to additional accessories, such as power banks. Understandably, the sliding strip 2014 can be various specifications of sliding strips within the photography industry, such as the Manfrotto standard, the Arri standard, among others.

Moreover, the housing 102 can be equipped with a first mounting interface 1026 and a second mounting interface 1027, with a first electronic contact 1028 positioned between the first mounting interface 1026 and the second mounting interface 1027. A second electronic contact (not shown) is situated between the first clamping member 211 and the second clamping member 212. The first clamping member 211 and the second clamping member 212 can clamp onto the first mounting interface 1026 and the second mounting interface 1027, respectively, establishing an electrical connection between the first electronic contact 1028 and the second electronic contact (not shown). The first clamping member and the second clamping member clamp onto the first mounting interface 1026 and the second mounting interface 1027, respectively, to mount the disassembly and assembly structure 101 and the photography accessory 201 onto the housing 102.

In a particular, yet non-exhaustive aspect, to further augment the functionality of the housing 102 and streamline the utilization of the photography accessory 201, a control module 103 and a connecting cable (omitted from the illustration) are incorporated. The control module 103 and the connecting cable are housed within an accommodation cavity 1021. The side wall of the housing 102 features at least one mounting interface, with a first electronic contact 1028 positioned between at least one first mounting interface 1026 and a second mounting interface 1027. The connecting cable terminates at both ends, connecting to the first electronic contact 1028 and the control module 103, respectively. Additionally, a second electronic contact (not depicted) resides on the side of the disassembly and assembly structure 101 adjacent to the housing 102. Engagement between the first electronic contact 1028 and the second electronic contact (not shown) establishes electrical circuit continuity.

Specifically, the control module 103 encompasses a power supply control module 103 and/or a data processing control module 103. With the power supply control module in place, the housing 102 of the mobile phone 104 transforms into a power bank, capable of charging externally connected photography accessories 201. The inclusion of the data processing control module facilitates electrical connection to the mobile phone 104, enabling the transmission of data from the photography accessory 201 to the mobile phone 104, thus sharing information.

Moreover, not all mounting interfaces are equipped with electronic contacts. Mounting interfaces on the disassembly and assembly structure 101 devoid of electronic contacts may solely serve to couple the housing 102 with the photography accessory 201. Electronic contacts can be selectively incorporated, with those positions featuring electronic contacts capable of facilitating power supply or sharing information through established electrical circuit continuity.

It is emphasized that the aforementioned examples serve as preferred illustrations and do not constitute limitations on the scope of the patent claims presented herein. Any structural modifications that are deemed equivalent, based on the disclosure and drawings of this disclosure, or their direct/indirect disclosure in related technical domains, fall within the ambit of patent protection afforded to the disclosure, in line with its underlying concept.

As used in the claims, the indefinite articles “a” and “an” should be understood to mean “one or more” unless explicitly stated otherwise or unless the context clearly dictates a singular interpretation. The use of these articles does not limit the claimed invention to a single instance of the referenced element but rather encompasses multiple instances where applicable.

What is claimed is:

1. A disassembly and assembly structure, comprising:
a mounting base;
a quick-release assembly comprising a first clamping member, a second clamping member, and a trigger;
wherein the first clamping member and the second clamping member are movably provided on the mounting base, and the first clamping member and the second clamping member are positioned opposite each other;
wherein the trigger is movably provided on the mounting base and comprises a first groove and a second groove respectively corresponding to the first clamping member and the second clamping member;
wherein the first clamping member cooperates with the first groove, the second clamping member cooperates with the second groove; and
wherein the trigger is configured to drive the first clamping member and the second clamping member between a first configuration in which the first clamping member and the second clamping member move apart from each other via the first groove and the second groove, and a second configuration in which the first clamping member and the second clamping member move towards each other via the first groove and the second groove.

2. The disassembly and assembly structure according to claim 1, further comprising a locking component movably provided on the mounting base and cooperating with the first clamping member and the second clamping member to secure at least one of the first clamping member or the second clamping member.

3. The disassembly and assembly structure according to claim 2, wherein the locking component comprises a wrench part and a locking part;
wherein the locking part is movably installed on the mounting base and cooperates with the first clamping member and the second clamping member; and
in response to an operation of the wrench part, the locking part is configured to drive the first clamping member and the second clamping member to lock to an external device.

4. The disassembly and assembly structure according to claim 3, wherein the locking component further comprises a locking post; and
wherein a first end of the locking post is threadedly connected to the locking part and a second end of the locking post is connected to the wrench part, enabling the wrench part to drive the locking part via the locking post.

5. The disassembly and assembly structure according to claim 3, wherein two opposite ends of the locking part are provided with a first locking groove and a second locking groove, respectively, and
the first clamping member comprises a first locking projection, which is within the first locking groove,
the second clamping member comprises a second locking projection, which is within the second locking groove,
the first locking groove and the second locking groove enabling the locking part to secure the first clamping member and the second clamping member to the external device.

6. The disassembly and assembly structure according to claim 5,
wherein the first locking projection comprises two first locking projections respectively on opposite sides of the first clamping member, and the second locking projection comprises two second locking projections respectively on opposite sides of the second clamping member;
wherein the first locking groove comprises two first locking grooves corresponding to the two first locking projections, and a first avoidance position is disposed between the two first locking grooves at a first end of the locking part;
wherein the second locking groove comprises two second locking grooves corresponding to the two second locking projections, and a second avoidance position is disposed between the two second locking grooves at a second end of the locking part; and
wherein the first clamping member and the second clamping member are provided in the first avoidance position and the second avoidance position, respectively;
wherein the two first locking projections of the first clamping member are provided in the two first locking grooves respectively; and
wherein the two second locking projections of the second clamping member are provided in the two second locking grooves respectively.

7. The disassembly and assembly structure according to claim 3, wherein an end of the first clamping member extending beyond the mounting base comprises a first clamping part, and an end of the second clamping member extending beyond the mounting base comprises a second clamping part;
wherein the disassembly and assembly structure further comprises an expansion interface positioned at an end of the mounting base opposite the first clamping part and the second clamping part, with a mounting groove provided on a side of the mounting base adjacent the expansion interface; and
wherein the wrench part is movably installed in the mounting groove.

8. The disassembly and assembly structure according to claim 1, wherein an inner wall of the first groove and an inner wall of the second groove each provide an inclined surface, enabling the first clamping member to cooperate with the inclined surface of the inner wall of the first groove and the second clamping member to cooperate with the inclined surface of the inner wall of the second groove,
driving the first clamping member and the second clamping member to move between the first configuration and the second configuration.

9. The disassembly and assembly structure according to claim 8, further comprising a locating part;
wherein the trigger comprises a limiting groove;
wherein the locating part is configured to be movable within the limiting groove and is movably connected to the mounting base; and
in response to a movement of the trigger, the locating part is configured to move out of the limiting groove and restrict a movement of the trigger, enabling the locating part to move outwards of the mounting base, causing at least part of the locating part to protrude outwards of the mounting base.

10. The disassembly and assembly structure according to claim 9, wherein the trigger comprises a trigger button and a trigger block;
wherein the trigger button is connected to the trigger block, and the trigger button protrudes outside the mounting base, and the trigger block is movably connected to the mounting base;
wherein the first groove and the second groove are inclinedly positioned on the trigger block in opposite directions from an end of the trigger block adjacent to the locating part;
in response to an actuation of the trigger button, the locating part is configured to move out of the limiting groove, and the first clamping member and the second clamping member are moved away from each other to be in a ready-to-install state;
in response to the first clamping member and the second clamping member clamping an external structure, the external structure prompts the locating part to revert inside the mounting base, enabling the trigger block to reset, and placing the first clamping member and the second clamping member in a clamped state.

11. The disassembly and assembly structure according to claim 10, wherein the locating part comprises a first limiting post and a second limiting post;
wherein the first limiting post comprises a larger diameter than that of the second limiting post;
wherein the trigger block is provided with an accommodation groove that connects to the limiting groove;
wherein the second limiting post exits the limiting groove and the first limiting post resides within the accommodation groove when the first clamping member and the second clamping member are in the ready-to-install state; and
wherein the first limiting post exits the accommodation groove and the second limiting post resides within the limiting groove when the first clamping member and the second clamping member are in the clamped state.

12. A photography accessory kit, comprising:
an accessory,
the disassembly and assembly structure according to claim 1;
wherein the accessory is positioned on the mounting base to be mounted on an external structure via the first clamping member and the second clamping member; and
wherein the accessory comprises at least one of a filter holder, a docking station, lighting equipment, a power bank, a microphone, or a handle.

13. The photography accessory kit according to claim 12, wherein the docking station comprises at least one electronic interface, a power supply cable for interfacing with or powering an external device; and
wherein a sliding strip is installed on a side of the docking station opposite the disassembly and assembly structure.

14. An electronic device kit, comprising:
a housing with an accommodation cavity configured to house an electronic device;
a plurality of disassembly and assembly structures according to claim 1;
wherein the disassembly and assembly structures are detachably installed on the housing to attach photography accessories to the housing.

15. The electronic device kit according to claim 14, wherein the housing is provided with a first mounting interface and a second mounting interface;
wherein a first electronic contact is provided between the first mounting interface and the second mounting interface, and a second electronic contact is positioned between the first clamping member and the second clamping member; and
wherein the first clamping member and the second clamping member being capable of securely clamping the first mounting interface and the second mounting interface, establishing an electrical connection between the first electronic contact and the second electronic contact.
